(19) United States
(12) Patent Application Publication
(10) Pub. No.: US 2003/0103837 A1
(43) Pub. Date: Jun. 5, 2003

(54) Dispensing and dosing device for bulk items

(76) Inventor: Theodor Kokeisl, Oberentfelden (CH)

Correspondence Address: WENDEROTH, LIND & PONACK, L.L.P., 2033 K STREET N. W., SUITE 800, WASHINGTON, DC, 20006-1021, US

(21) Appl. No.: 10/149,677

(22) PCT Filed: Dec. 15, 2000
(86) PCT No.: PCT/CH00/00666

(30) Foreign Application Priority Data
Dec. 16, 1999 (CH) 2311/99

(51) Int. Cl. B65G 1/00

(52) U.S. Cl. 414/288

(57) ABSTRACT

The invention relates to a dispensing and dosing device for bulk items containing a funnel-shaped receiving element for bulk items, embodied as a base body (1). A rotating ring (3) is surrounded on the outside by a bearing ring (6) which is secured to the base body (1). A toothed drive ring (10) is connected to the rotating ring (3) and is driven by a side pinion (12). An scraper (15) projects eccentrically up to a slider (20). The slider (20) can be moved at the side by a hand lever (22, 24). Said base body (1), rotating ring (3) and bearing ring (6) can be separated from each other and are sealed to each other. The inventive design facilitates simple and economically feasible construction, whereby the bulk item can be dispersed to the lowest discharge area.

The invention relates to a dispensing and dosing device for bulk items according to the characterising clause of claim 1.

A dispensing and dosing device with a laterally moving slide closure is prior art from DE-PS 256 147. However, the relatively high constructive expense of the components is disadvantageous.

The invention is intended to solve the problem of achieving a simpler and cheaper method of construction, whereby the parts should easily be separated from each other for cleaning purposes.

The invention with which this problem will be solved is evident from the characterising section of claim 1.

As the result of the design of the dosing device with a bearing ring secured underneath to the base body and a rotating ring lying between these with a driving rim, it is possible to achieve an especially compact, modular means of construction requiring few parts, which facilitates cleaning and maintenance works. In practice, where different bulk items are involved, great importance attaches to the fact that no mixing takes place, in particular when bulk items have different colours. Since the components coming into contact with the bulk items are sealed off from each other, wet cleaning is possible. In addition, base body, rotating ring and bearing ring can also be cleaned when separated from each other.

Two design examples are shown in the drawing.

The drawings show:

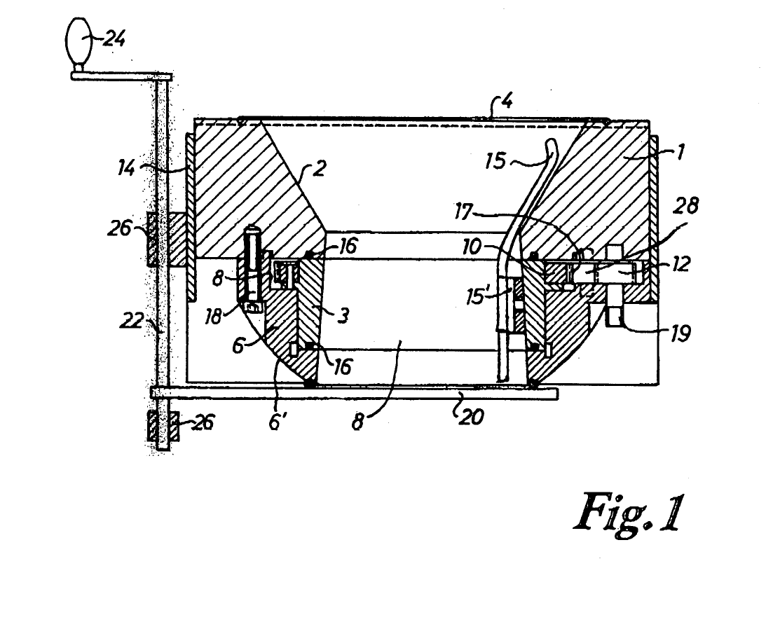

FIG. 1 a vertical section through the dispensing and dosing device with scraping and loosening element,

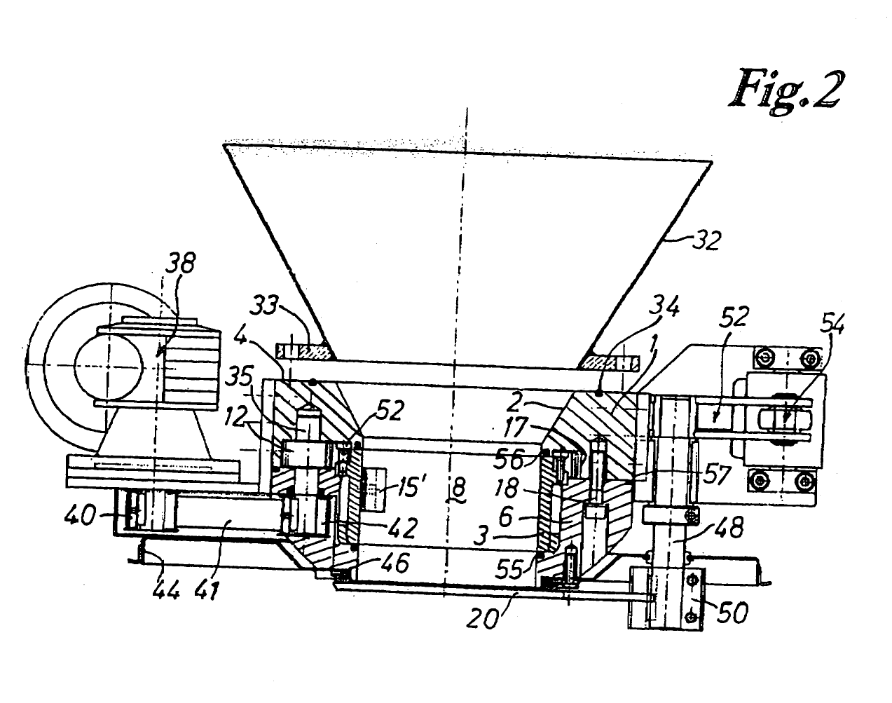

FIG. 2 a design variant of the dispensing and dosing device without scraping and loosening element.

A housing-like base body contains, in accordance with FIG. 1, a conical funnel interior wall 2. This base body 1 is in the form of a massive, thick-walled body, which can be made from metal or plastic. The top edge 4 of the base body 1 is intended for the positioning of a supply hopper of bulk items. A cylindrical rotating ring 3 abuts against the lower edge of the base body 1, the borehole 8 of said rotating ring being cylindrical or slightly conical and connecting without stepping to a cylindrical borehole part of the base body 1.

This rotating ring, which is connected via a coupling part 15′ with a scraping and loosening element 15, can rotate relative to the base body 1. The rotating ring 3 is externally surrounded by a stationary bearing ring 6. The borehole of this bearing ring 6 includes several steps, the lowest of which overlaps the rotating ring 3. The bearing ring 6 is secured to the base body 1 by a number of screws 18 distributed along the perimeter. In this way the rotating ring 3 is held in such a way that it can rotate between seals 16 of the bearing ring 6 and of the base body 1. A crown-type driving ring 10 is connected immovably or integrally to the rotating ring 3, said driving ring having a radial distance from a borehole part 8 of the bearing ring 6. This driving ring 10 contains a toothed wheel, which engages via an intermediate wheel 28 in a pinion 12, which is provided with a shaft 19 which can be coupled to a motor drive, not shown.

As a design variant, a toothed belt could be slung around a toothed wheel. When the drive shaft 19 rotated this will thus set the scraper and loosening element 15, which extends downwards to the slider 20, in rotation and prevent any bridging of the bulk items when the slider is opened.

The scraping and loosening element 15, which is detachably inserted into the coupling element 15′, runs in the upper part at a slight distance parallel to the funnel wall 2 and extends downwards to the slider 20, or the dispensing opening respectively. The scraping and loosening element 15 is additionally inclined backwards in the upper area, relative to the direction of rotation.

The laterally-moveable slider 20 is of a construction which is prior art and can pivot about a vertical axis of rotation. The pivoting motion is manually performed via an actuating rod 22 with a handle 24. The actuating rod 22 is secured so as to run on bearings 26. As a design variant, the actuation of the slider could also be performed by a motor drive.

This device is also characterised in that in place of the slider 20 which is formed from a solid plate, one such made from two reciprocally-sealing dome-shaped plates could also be used, as can be deduced from PCT application no. PCT/CH99/00630. The bearing ring 6 is outlined with a lower area 6′ which is correspondingly dome-shaped, by which means such dome-shaped plates could be fitted, at no great expense, in place of the slider 20. This additional type of application of the device would allow for more precise dosing compared with the flat plates.

In the form of design shown in FIG. 2, the same reference numbers indicate the same parts and same functions as in FIG. 1. The supply hopper for the bulk items 32 is in the form of a conical funnel, which can be detachably secured by means of a flange 33 via a seal 34 to the upper edge 4 of the base body 1. The toothed drive wheel 12 runs on bearings with its shaft 35 in boreholes in the base body 1 and in the bearing body 6. The rotating motion is transmitted by a drive motor 38 to the toothed wheel 12 via a pulley 40 and a belt 41 to a pulley 42 sitting on the shaft of the toothed wheel 12. The belt 41 could also be a toothed belt. Underneath the belt 41 there is a mounting 44 for a protective or closure hood.

To seal the slider 20 when it is closed, there is a sealing tube 46 on the underside of the bearing ring 6. The shaft 48 to pivot the slider 20 pivots on bearings underneath in a bearing 50. The pivoting motion of the shaft 48 occurs via intermediate members 52 through a power drive 54, for example a dual-action hydraulic or pneumatic lifting element 54 or an electromotor.

The toothed wheel 12 engages directly in the toothed ring 17 of the rotating ring 3. There is an overflow space 52 to collect any leakages.

The base body 1 abuts via seals 57 which can be released by means of screws 18 on the bearing ring 6. The rotating ring 3 is sealed off underneath by a sealing ring 55 from the bearing ring 6 and above by a sealing ring 56 from the base body 1. This means base body, rotating ring 3 and bearing ring 6 can be separated from each other with a few manipulations.

At least the bearing ring 6 and advantageously also the base body 1 are made out of an abrasion-resistant low-friction synthetic material, for example POM.

1. Dispensing and dosing device for bulk items with an open-topped funnel-shaped receiving element for bulk items, and with a moveable closure element (20) arranged at the lower outlet end, with a bulk item supply funnel (32) placed above the receiving element for bulk items, characterised in that the receiving element for bulk items is in the form of a housing-type base body (1) against which the bulk item supply funnel (32) detachably abuts and against which a cylindrical rotating ring (3) abuts underneath, where the rotating ring (3) which rotates relative to the base body (1) is surrounded externally by a bearing ring (6), which is fixed onto the base body (1) and supports the rotating ring (3) underneath, where the rotating ring (3) can be connected by side driving elements (12) to turn the latter and in that the base body (1), the rotating ring (3) and the bearing ring (6) are separable from each other and are sealed off from each other.

2. Dispensing and dosing device for bulk items according to claim 1, characterised in that the lower outlet end is closed by a laterally moving slider (20), which abuts against a ring-shaped seal (46) on the lower end of the bearing ring (6).

3. Dispensing and dosing device for bulk items according to claim 1, characterised in that a scraping and loosening element (15) is detachably fixed onto the rotating ring (3).

4. Dispensing and dosing device for bulk items according to claim 3, characterised in that the scraping and loosening element (15) extends eccentrically downwards to the vicinity of the slider (20), runs above along the inner wall of the funnel (2) and the upper area is inclined backwards with respect to the direction of rotation.

5. Dispensing and dosing device for bulk items according to claim 2, characterised in that the slider (20) can be moved by a hand lever (22, 24).

6. Dispensing and dosing device for bulk items according to claim 2, characterised in that the slider (20) can be adjusted by means of a power drive.

7. Dispensing and dosing device for bulk items according to one of the previously claims 1 to 6, characterised in that the rotating ring (3) displaying a driving rim (17) is externally surrounded by a bearing ring (6) with a graduated borehole, with the driving rim engaging in a toothed driving wheel (12), which runs on bearings in the base body (1) and in the bearing ring (6).

8. Dispensing and dosing device for bulk items according to one of the previous claims 1 to 7, characterised in that the bearing ring (6) is equipped with a corresponding dome-shaped lower area (6′), through which, in place of the slider (20), two reciprocally-sealing dome-shaped plates can be fitted as the dosing element.
